(19) United States
(12) Patent Application Publication
(10) Pub. No.: US 2025/0160251 A1
(43) Pub. Date: May 22, 2025

(54) Floating Header End Divider Point with Torsional Bushing

(71) Applicant: AGCO Corporation, Duluth, GA (US)

(72) Inventors: Randall Lohrentz, Buhler, KS (US); William H. Thompson, Hesston, KS (US)

(21) Appl. No.: 18/943,266

(22) Filed: Nov. 11, 2024

Related U.S. Application Data
(60) Provisional application No. 63/601,413, filed on Nov. 21, 2023.

(51) Int. Cl. A01D 41/14

(52) U.S. Cl. CPC A01D 41/141

(57) ABSTRACT

A harvesting header has a point down-pressure mechanism for a divider point. The divider point is mounted on a receiver with a torsional bushing configured to apply a biasing down-pressure force to rotate the divider point. The down pressure mechanism has an upper stop and a lower stop formed as part of the pivot block. The upper stop and lower stop are oriented to form a mouth that is configured to receive the receiver tongue when the receiver is connected to the bushing, the lower stop engaging the receiver tongue to prevent the receiver from rotating downward beyond a preselected angle and the upper stop engaging the receiver tongue to prevent the receiver from rotating upward beyond a preselected angle such that the bushing enables pivoting motion of the receiver between a downward position and an upward position while providing a biased down-pressure force.

### CROSS-REFERENCE TO RELATED APPLICATIONS

This application claims the benefit of the filing date of U.S. Provisional Patent Application 63/601,413, “Floating Header End Divider Point with Torsional Bushing,” filed Nov. 21, 2023, the entire disclosure of which is incorporated herein by reference.

### BACKGROUND OF THE INVENTION

### Field of Invention

This disclosure relates to harvesting headers for use with self-propelled crop-harvesting machines, and particularly to dividers and divider points.

### Description of Related Art

Self-propelled agricultural harvesters are well known and include, by way of example, combine harvesters, windrowers, and forage harvesters, all of which typically include a frame or chassis, an operator cab, an engine, and ground-engaging wheels or tracks. A cutting or pick-up header is often carried by the harvester, the header typically being considerably wider than the harvester and mounted to the front side of a feeder house.

Crop material collected by the header is conveyed into the feeder house before being conveyed in a generally rearward direction to crop-processing apparatus. In the case of a combine harvester, the processing apparatus serves to thresh the crop material and separate grain therefrom, whereas, in the case of a forage harvester or windrower, the crop material is typically passed through conditioning rollers.

Headers typically include a pair of crop dividers on opposite ends of a crop-gathering mechanism. The dividers split the standing crop to the outside of the header while the crop to the inside of the divider is where it may be harvested by one or more harvesting tools, such as a set of oscillating blades and conveyed to the center of the header. Dividers may carry divider points, which may extend forward or upward from the front of the divider. The divider points may be of various designs, depending on the crop to be harvested. Some divider points may extend well in front of the header and may contact the ground in certain terrain (e.g., hilly, rough, etc.).

Varying crops and conditions can require different dividers and adjustment of dividers. If the divider is not functioning properly a ragged cut and loss of crop can result at the end of the header. Dividers can also gouge the ground with the resulting force damaging the header. An improper functioning divider can also cause plugging in the reel area such that detached crop will not clean out and is dragged by the header. A floating divider configured to follow the contour of the ground may bounce or may float over crop because of lack of force to hold it in the proper position with respect to the ground.

### SUMMARY OF THE INVENTION

In one aspect, the invention is directed to a harvesting header for harvesting a crop as the harvesting header traverses the ground, the harvesting header having a pair of end dividers, each end divider having a divider point at an end of the divider. Each divider point is mounted on a frame of the divider with a point down-pressure mechanism. The point down pressure mechanism includes a point mount plate attached to the frame, a pivot block extending in an upwardly direction from the point mount plate, where the pivot block contains a sleeve. A receiver has a base with upwardly extending receiver arms having ends that engage opposing sides of the sleeve, the receiver including a receiver tongue that extends between the receiver arms. The divider point is mounted on the receiver. A torsional bushing is received in the sleeve, where the receiver arms are pivotably mounted to the bushing such that the torsional bushing is configured to apply a biasing down-pressure force to rotate the divider point towards the ground relative to the point mount plate. The down pressure mechanism has an upper stop and a lower stop formed as part of the pivot block. The upper stop and lower stop are oriented to form a mouth that is configured to receive the receiver tongue when the receiver is connected to the bushing, the lower stop engaging the receiver tongue to prevent the receiver from rotating downward beyond a preselected angle and the upper stop engaging the receiver tongue to prevent the receiver from rotating upward beyond a preselected angle such that the bushing enables pivoting motion of the receiver between a downward position and an upward position while providing a biased down-pressure force.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a simplified front perspective view of an example combine harvester;

FIG. 2 illustrates a header that may be used with combine harvester of FIG. 1;

FIG. 3 illustrates a side view of a divider of the header shown in FIG. 2 and a divider point that may be attached to the header;

FIG. 4 illustrates a side view of the divider of FIG. 3 with the divider point in a first position;

FIG. 5 illustrates a side view of the divider of FIG. 3 with the divider point in a second position;

FIG. 6 illustrates an exploded view of a divider point down-pressure mechanism;

FIG. 7 illustrates a perspective view of a portion of the divider point down-pressure mechanism of FIG. 6; and

FIG. 8 illustrates a side view of a portion of the divider point down-pressure mechanism of FIG. 6.

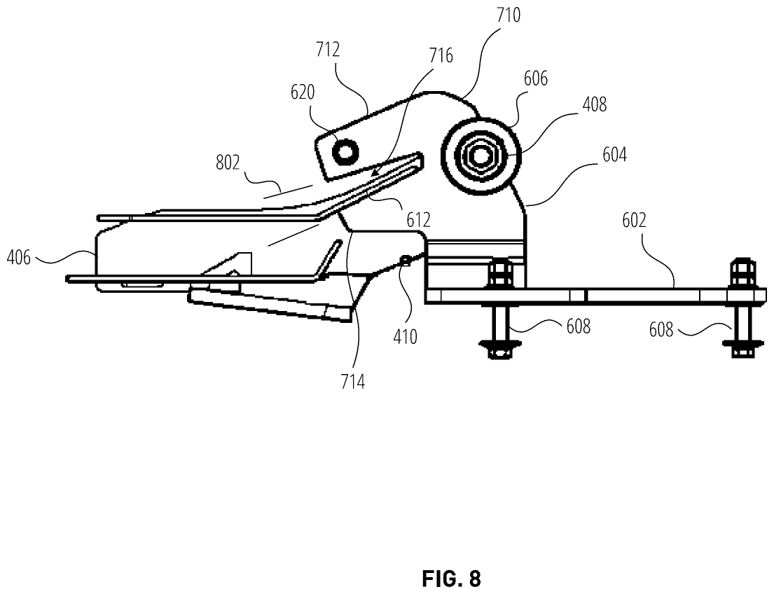

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description. Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right” are used as a matter of mere convenience and are determined by standing at the rear of the machine facing in its normal direction of travel. Furthermore, the various components shown or described herein for any specific application of this invention can be varied or altered as anticipated by this invention and the practice of a specific application of any element may already by widely known or used in the art by persons skilled in the art and each will likewise not therefore be discussed in significant detail.

As used herein, the singular forms following “a,” “an,” and “the” are intended to include the plural forms as well, unless the context clearly indicates otherwise. As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded. As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “top,” “bottom,” “upper,” “lower,” “above,” “beneath,” “side,” etc., is used for clarity and convenience in understanding the disclosure and accompanying drawings, and does not connote or depend on any specific preference or order, except where the context clearly indicates otherwise.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

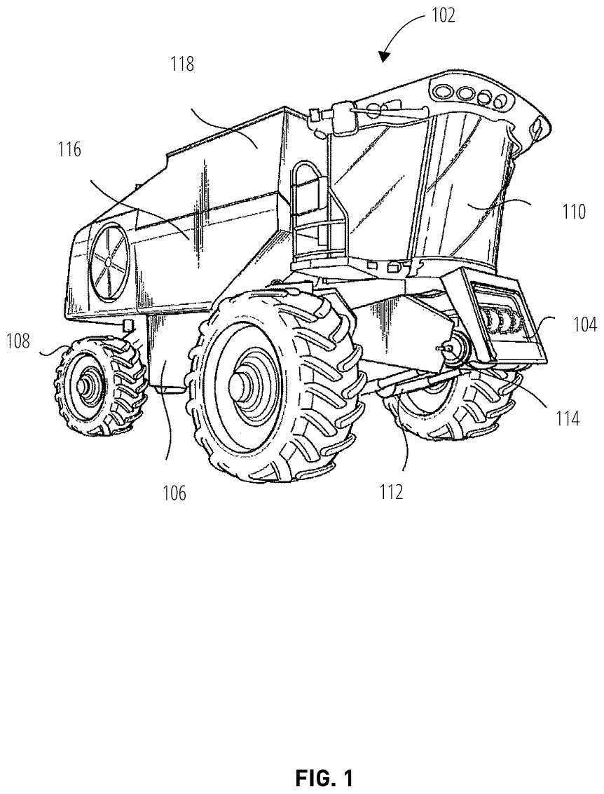

FIG. 1 illustrates an example agricultural harvester embodied as a combine harvester 102. In the context of the present disclosure, the example combine harvester 102 is merely illustrative, and other machines and/or implements with like functionality may deploy certain embodiments disclosed herein, such as forage harvesters, etc. The example combine harvester 102 is shown in FIG. 1 without a header attached and includes a feeder house 104 carried by a chassis 106 supported by wheels 108. An operator cab 110 is mounted to the chassis 106. In some embodiments, other or additional forms of travel may be used, such as tracks. Hydraulic cylinders 112 are shown affixed to the underside of the feeder house 104 on one end and to the chassis 106 on the other end. The feeder house 104 may move (e.g., up, and down, pitch, tilt, etc.) based on actuation of the hydraulic cylinders 112, which causes a detachably coupled header to also be raised, lowered, pitched, and/or tilted. A rotating support shaft 114 may be configured to provide mechanical power to a header during operation of the combine harvester 102. The rotating support shaft 114 may be configured to operate at various speeds, as described in, for example, U.S. Pat. No. 9,434,252, “Power Takeoff Drive System for a Vehicle,” issued Sep. 6, 2016.

In general, the combine harvester 102 cuts crop materials (e.g., using the header), and the cut crop materials are delivered to the front end of the feeder house 104. Such crop materials move upwardly and rearwardly within and beyond the feeder house 104 (e.g., by a conveyer) until reaching a processing system 116 that includes a thresher rotor. In one embodiment, the thresher rotor may comprise an axial-based, twin rotor, such as that found in a Fendt Ideal® Combine by AGCO. Other designs may be used, such as a single, transverse rotor as found in a Gleaner® Super Series Combine by AGCO. The thresher rotor processes the crop materials in known manner and passes a portion of the crop material (e.g., heavier chaff, corn stalks, etc.) toward the rear of the combine harvester 100 and another portion (e.g., grain and possibly light chaff) through a cleaning process. In the processing system 116, the crop materials undergo threshing and separating operations. In other words, the crop materials are threshed and separated by the thresher rotor operating in cooperation with well-known foraminous processing members in the form of threshing concave assemblies and separator grate assemblies, with the grain (and possibly light chaff) escaping through the concave assemblies and the grate assemblies and to a cleaning system beneath the processor to facilitate the cleaning of the heavier crop material. Bulkier stalk and leaf materials are generally retained by the concave assemblies and the grate assemblies and are discharged out from the processing system 116 and ultimately out of the rear of the combine harvester 102. The cleaned grain that drops to the bottom of the cleaning system is delivered by a conveying mechanism that transports the grain to an elevator, which conveys the grain to a grain bin 118 located at the top of the combine harvester 102. Any remaining chaff and partially or unthreshed grain is recirculated through the processing system 116 via a tailings return conveying mechanism. Because combine processing is known to those having ordinary skill in the art, further discussion thereof is omitted here for brevity.

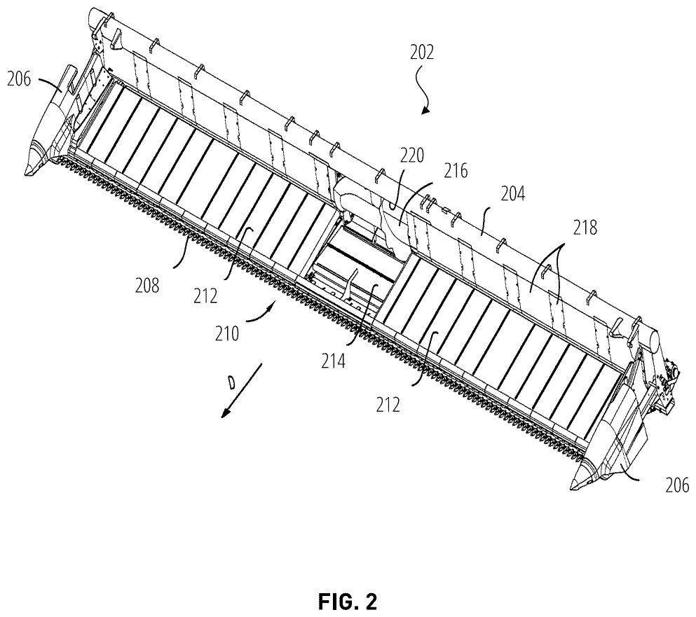

FIG. 2 is a simplified view of a header 202 that may be attached to the feeder house 104 of the combine harvester 102 (FIG. 1) and used to harvest a crop by being advanced in a generally forward direction D so that the crop can be fed to the feeder house 104 and further processed by the processing system 116. The header 202 may broadly include a header frame 204, side dividers 206, a cutterbar assembly 208, and a draper assembly 210 which may include side drapers 212 and a center draper 214. The header 202 may also include a central collecting auger 216 spaced rearwardly of the center draper 214 and a reel (not shown) that extends the length of the header frame 204 and is configured to direct upstanding crop into the header 202. The header frame 204 may include upright rear panels 218 that cooperatively define an upright rear wall of the header 202, with a centrally located opening 220 being defined by the rear wall and serving as a crop passageway from the header 202 to the feeder house 104 of the combine harvester 102. The cutterbar assembly 208 is depicted as an oscillating blade but may be any other tool used for harvesting crops that come into contact with the cutterbar assembly 208.

The dividers 206 may serve to define boundaries between crop material being harvested and standing crop (typically, material to be harvested in a subsequent pass through the field) by directing crop material on one side of the divider 206 toward the cutterbar assembly 208 and crop material on the other side of the divider 206 away from the cutterbar assembly 208. Headers are described in more detail in, for example, commonly assigned U.S. Pat. No. 7,886,511, “Draper Head with Flexible Cutterbar Having Rigid Center Section,” issued Feb. 15, 2011; U.S. Pat. Nos. 10,194,588, and 8,857,143, “Frame for Harvesting Header with Continuous Section,” issued Oct. 14, 2014.

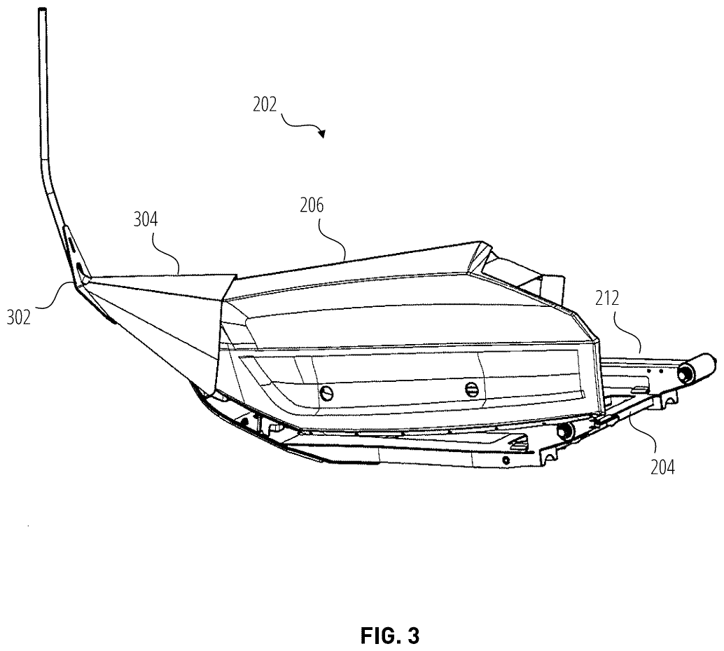

FIG. 3 is a simplified side perspective view showing more detail of one divider 206 of the header 202 shown in FIG. 2. A divider point 302 is secured to the divider 206 and, in the embodiment shown, includes a rod extending forward and upward from the divider 206. The divider point 302 may also include a shroud 304 surrounding an interface between the divider point 302 and the divider 206. The parts of the divider 206 may be designed and arranged to divide crop material and direct crop material to be harvested toward the cutterbar assembly 208. The divider point 302 may attach to the divider 206 such as described in commonly assigned U.S. patent application Ser. No. 17/629,769 entitled “Divider Points, Harvesting Headers Configured to Receive Removable Divider Points, and Related Methods” and U.S. patent application Ser. No. 17/637,409 entitled “Rotatable Wing Dividers, Harvesting Headers, and Agricultural machines Having Rotatable Wing Dividers.”

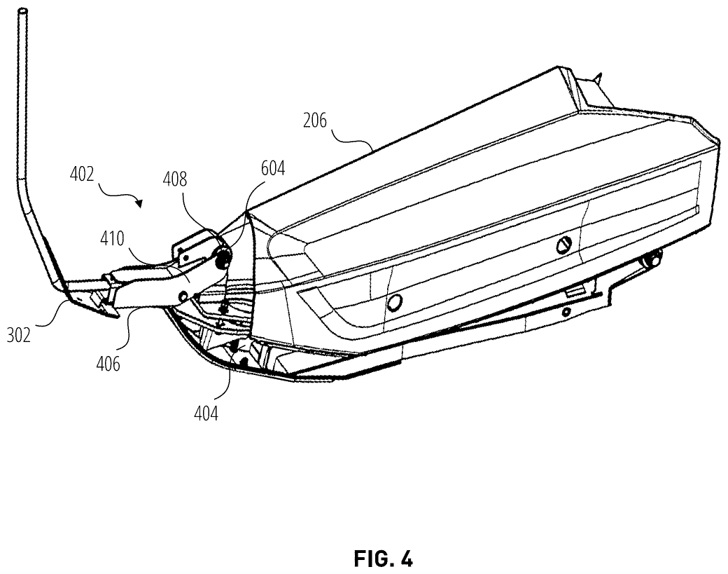

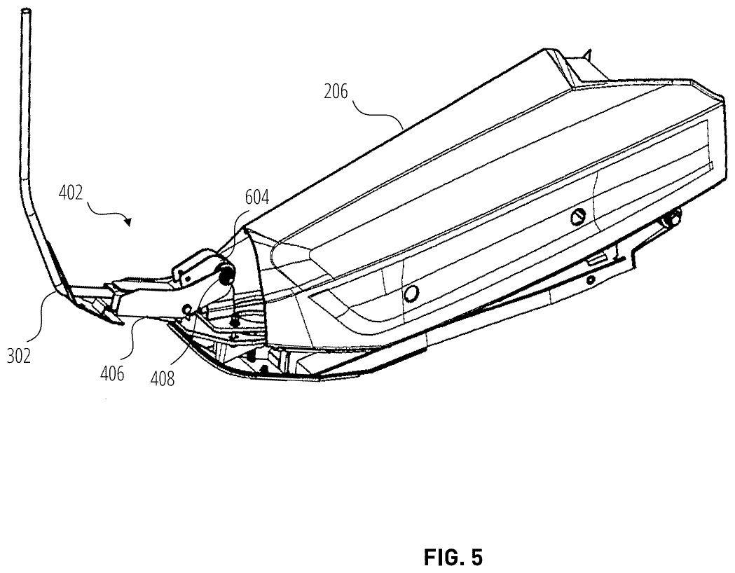

FIG. 4 is a simplified perspective view of the divider 206 and divider point 302 with the shroud 304 removed to expose a divider point down-pressure mechanism 402 mounted to a frame 404 of the divider 206 according to an embodiment of the invention. The divider point 302 is mounted on a receiver 406 and the divider point down-pressure mechanism 402 uses a pivoting element (e.g., a bushing) 408 that includes a torsional biasing element configured to allow pivoting motion of the receiver 406 between a downward position as shown in FIG. 4 and an upward position as shown in FIG. 5 while providing a biased down-pressure force suitable to hold the divider point 302 in a desired position with respect to the ground as will be explained below.

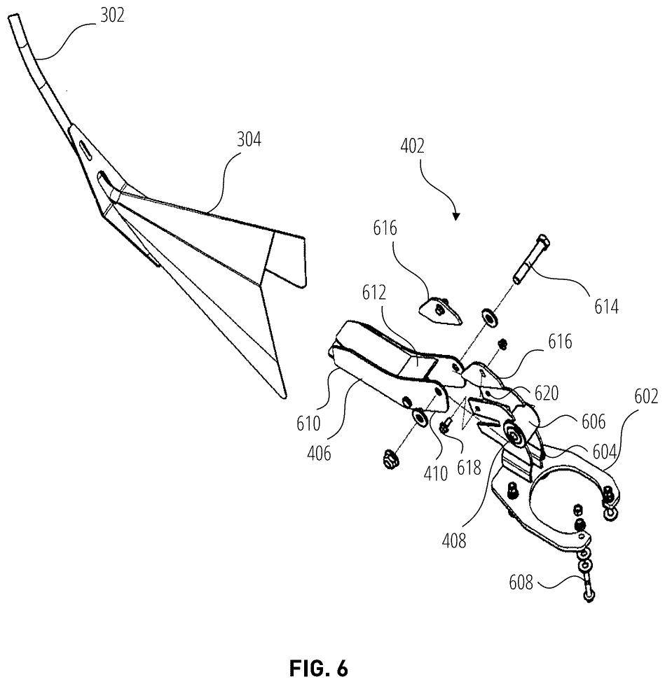

As perhaps best seen in the exploded view of FIG. 6, the divider point down-pressure mechanism 402 includes a point mount plate 602 that attaches to the frame 404 of the divider 206. Extending in an upwardly direction from the point mount plate 602 is a pivot block 604 that contains a sleeve 606, the sleeve 606 forming a pivot point about which the receiver 406 is able to pivot. In the illustrated embodiment, the pivot block 604 is formed with plural plates welded to and extending upwards from the point mount plate 602 onto which the sleeve 606 is welded. Accordingly, the pivot-forming sleeve 606 is positioned vertically above the point mount plate 602. The point mount plate 602 is suitably attached to the frame 404 (FIG. 4), such as with the illustrated bolt and nut sets 608.

As set forth above, the divider point 302 and the shroud 304 are mounted on the receiver 406. The receiver 406 has a base 610 with upwardly extending receiver arms 410 having ends that engage opposing sides of the sleeve 606. A receiver tongue 612 may extend between the receiver arms 410. The receiver arms 410 are pivotably mounted to the bushing 408 with a suitable bolt and nut set 614.

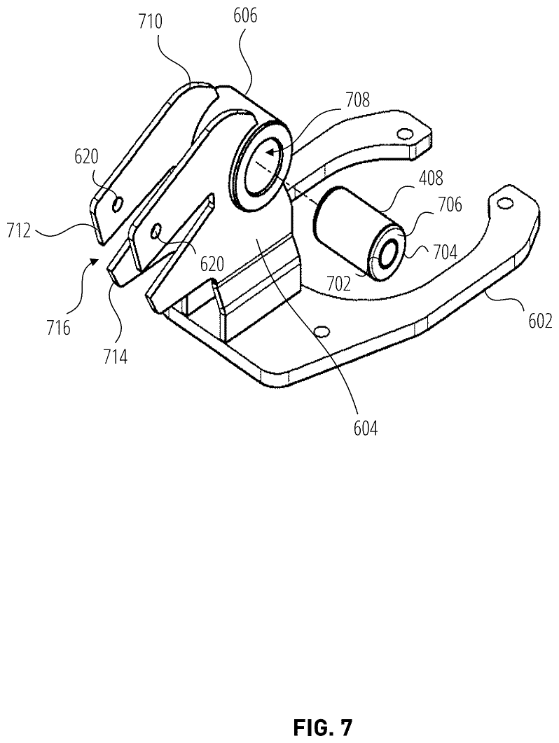

As stated above, the bushing 408 desirably is a torsional biasing element configured to apply a biasing force to rotate the receiver 406 relative to the point mount plate 602. Turning also now to FIG. 7, the bushing 408 has an inner and outer concentric cylinders 702, 704 with an elastomeric material 706 between the two cylinders 702, 704. The bushing 408 is press fit into a bore 708 formed by the sleeve 606. The receiver arms 410 connect to the inner cylinder 704 with the bolt and nut sets 614. The elastomeric material 706 permit the cylinders 702, 704 to move relative to one another, but tend to urge the cylinders toward a particular orientation. Such torsional biasing bushings 408 would be known to one skilled in the art. In other embodiments, the torsional biasing element may include a coil spring or other biasing element.

The point down-pressure mechanism 402 desirably includes features to prevent movement of the receiver 406 past selected limits. In the illustrated example, the pivot block 604 has a head 710 with at least one upper stop 712 and at least one lower stop 714 formed as part of the pivot block 604. The upper stop 712 and lower stop 714 are oriented to form a mouth 716 that is configured to receive the receiver tongue 612 when the receiver 406 is connected to the bushing 408. The lower stop 714 engages the receiver tongue 612 to prevent the receiver 406 from rotating downward beyond a preselected angle. The upper stop 712 engages the receiver tongue 612 to prevent the receiver 406 from rotating upward beyond a preselected angle. The upper and lower stops 712, 714 may be configured so as to form an angle A 802 such that there is a range of motion that the receiver 406, and thus the divider point 302, may pivot relative to the sleeve 606. Desirably, the angle A 802 formed by the mouth 716 is between 5 and 15 degrees. The torsional bushing 408 may tend to keep the divider point 302 in the lowered position, as shown in FIG. 4, absent an external upward force on the divider point 302. FIG. 5 shows the divider point 302 in another position in which the divider point 302 is rotated upward as compared to the view shown in FIG. 4 against the biasing for of the torsional bushing 408. Referring again to FIG. 6, lock plates 616 may be attached with bolt and nut sets 618 and lock bolt openings 620 if it is desired to prevent the point down-pressure mechanism 402 from permitting the divider point 302 from pivoting.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. A harvesting header for harvesting a crop as the harvesting header traverses the ground, the harvesting header having a pair of end dividers, each end divider having a divider point at an end of the divider, with each divider point mounted on a frame of the divider with a point down-pressure mechanism, the point down pressure mechanism comprising:
a point mount plate attached to the frame;
a pivot block extending in an upwardly direction from the point mount plate, wherein the pivot block contains a sleeve;
a receiver having a base with upwardly extending receiver arms having ends that engage opposing sides of the sleeve, the receiver comprising a receiver tongue that extends between the receiver arms, and wherein the divider point is mounted on the receiver;
a torsional bushing received in the sleeve, wherein the receiver arms are pivotably mounted to the bushing such that the torsional bushing is configured to apply a biasing down-pressure force to rotate the divider point towards the ground relative to the point mount plate; and
an upper stop and a lower stop formed as part of the pivot block, wherein the upper stop and lower stop are oriented to form a mouth that is configured to receive the receiver tongue when the receiver is connected to the bushing, the lower stop engaging the receiver tongue to prevent the receiver from rotating downward beyond a preselected angle and the upper stop engaging the receiver tongue to prevent the receiver from rotating upward beyond a preselected angle such that the bushing enables pivoting motion of the receiver between a downward position and an upward position while providing a biased down-pressure force.

2. The harvesting header of claim 1 wherein the pivot block is formed with plural plates welded to and extending upwards from the point mount plate.

3. The harvesting header of claim 1 wherein the torsional bushing has inner and outer concentric cylinders, with an elastomeric material between the inner and outer cylinders.

4. The harvesting header of claim 1 wherein the bushing is press fit into a bore formed by the sleeve.

5. The harvesting header of claim 1 wherein the upper and lower stops form an angle A such that there is a range of motion that the receiver may pivot relative to the sleeve.

6. The harvesting header of claim 5 wherein the angle is between 5 and 15 degrees.

7. The harvesting header of claim 1 further comprising a lock plate configured to prevent the point down-pressure mechanism from permitting the divider point from pivoting.
